(19) United States
(12) Patent Application Publication
(10) Pub. No.: US 2012/0129698 A1
(43) Pub. Date: May 24, 2012

(54) Suspension Composition And Method Of Preparing The Same

(76) Inventors: Laura L. Brasher, Clinton, NJ (US); Michael D. Capracotta, Canton, MI (US)

(21) Appl. No.: 13/377,420

(22) PCT Filed: Jun. 11, 2010
(86) PCT No.: PCT/US10/38329

§ 371 Date: Feb. 3, 2012

Related U.S. Application Data
(60) Provisional application No. 61/186,734, filed on Jun. 12, 2009.

(51) Int. Cl. A01N 43/70; A01N 25/04; A01P 13/00; A01N 47/30

(52) U.S. Cl. 504/234; 504/330; 504/361

(57) ABSTRACT

A suspension and a method of preparation are provided herein. The suspension comprises a continuous aqueous phase (a), a substance (b) that is capable of transport through the aqueous phase thereby resulting in Ostwald ripening of the substance, and a dispersing agent (c). The dispersing agent comprises the reaction product of at least one monomer (i) and at least one additional monomer (ii). The at least one monomer (ii) is represented by the general formula (1) wherein R is hydrogen, an alkyl group or an aryl group, R1 is an alkyl group having at least 2 carbon atoms, k is 2 to 4, and n is at least about 10. The at least one additional monomer (ii) has unsaturated functionality and contains at least one carbonyl group. The dispersing agent is present in the suspension in an amount sufficient to limit Ostwald ripening of the substance (b) in the suspension.

R₂C═CR—O—R¹—(OCₖH₂ₖ)ₙ—OH (I)

### CROSS-REFERENCE TO RELATED APPLICATIONS

The subject patent application claims priority to, and all the benefits of, U.S. Provisional Patent Application Ser. No. 61/186,734 filed on Jun. 12, 2009. The entirety of this provisional patent application is expressly incorporated herein by reference.

### BACKGROUND OF THE INVENTION

The instant invention generally relates to a suspension composition comprising a continuous aqueous phase and a substance that is capable of transport through the aqueous phase thereby resulting in Ostwald ripening of the substance in the suspension composition. More specifically, the instant invention relates to suspension composition comprising a dispersing agent that is capable of limiting Ostwald ripening of the substance in the suspension composition.

### DESCRIPTION OF THE RELATED ART

Suspension compositions, or compositions including particles dispersed in a fluid, are useful for many applications. One specific example of a useful suspension composition is a suspension concentrate including a pesticide component that is used for water-based crop protection formulations. The water-based crop protection formulations are typically prepared by diluting the suspension concentrates with water, with the water-based crop protection formulations applied to crops to thereby deliver the pesticide component.

Stability of suspension compositions is generally a concern, especially for the suspension concentrates described above. Storage and temperature cycling generally exacerbate problems with stability of suspension compositions, and there is a constant desire to improve storage and freeze/thaw stability of suspension compositions to prevent separation between the particles and the fluid.

Ostwald ripening is a phenomenon that leads to instability of some suspension compositions. Although many substances do not exhibit Ostwald ripening, Ostwald ripening can occur whenever the suspension compositions contain a substance that is capable of being transported through the fluid from one particle to another, thereby resulting in spontaneous particle size growth. Ostwald ripening generally proceeds by smaller particles being incorporated into larger particles because larger particles are more energetically favored than smaller particles. Particle size growth due to Ostwald ripening commonly leads to instability of the suspension compositions because larger particles are generally more prone to settling out of the suspension compositions.

Ostwald ripening is generally facilitated by dissolution of the substances into the fluid, which can occur even if the solubility of the substances is low. However, high solubility of the substances increases the incidence of Ostwald ripening and, for this reason, many water-based crop protection formulations make use of pesticide components having a relatively low water solubility of less than about 100 ppm in water.

It is known to use various dispersing agents to enhance stability of suspension compositions. Examples of such dispersing agents include poloxamers and the recently developed Atlox® 4913, which is an industry benchmark and which has a structure containing a backbone of methyl methacrylate and methacrylic acid units. While Atlox® 4913 is widely used, efforts continue to develop novel dispersing agents that perform as well as or better than Atlox® 4913 for purposes of stabilizing suspension compositions and, in particular, for purposes of inhibiting Ostwald ripening. Improvements in inhibition of Ostwald ripening by novel dispersing agents could lead to the ability to use more water soluble substances while still enabling sufficient stability of the suspension compositions to be achieved.

### SUMMARY OF THE INVENTION AND ADVANTAGES

The instant invention provides a suspension composition and a method of preparing the suspension composition. The suspension composition comprises a continuous aqueous phase (a), a substance (b) that is capable of transport through the aqueous phase thereby resulting in Ostwald ripening of the substance in the suspension composition, and a dispersing agent (c). The dispersing agent comprises the reaction product of at least one monomer (i) and at least one additional monomer (ii). The at least one monomer (ii) is represented by the general formula (I):

R₂C═CR—O—R¹—(OCₖH₂ₖ)ₙ—OH (I)

wherein R is hydrogen, an alkyl group or an aryl group; R¹ is an alkyl group having at least 2 carbon atoms; k is 2 to 4; and n is at least about 10. The at least one additional monomer (ii) has unsaturated functionality and contains at least one carbonyl group. The dispersing agent is present in the suspension composition in an amount that is sufficient to limit Ostwald ripening of the substance (b) in the suspension composition.

The method of preparing the suspension composition comprises the steps of (I) combining the in a vessel the continuous aqueous phase (a), the substance (b), the dispersing agent (c), and (d) grinding media to form a mixture, and (II) decreasing a size of the substance (b) in the mixture to a volume-weighted average particle size of from about 1.5 to about 2.0 micrometers to form the suspension composition.

The suspension compositions of the instant invention exhibit excellent stability, and limited Ostwald ripening, due to the use of the particular dispersing agent (c), and stability of the suspension compositions is comparable to stability achieved when the benchmark Atlox® 4913 dispersing agent is used, with inhibition of Ostwald ripening superior to results achieved with Atlox® 4913 under certain circumstances.

### DETAILED DESCRIPTION OF THE INVENTION

A suspension composition and a method of preparing the suspension composition are provided. Suspension composition refers to a composition including solid particles dispersed in a fluid. For purposes of the instant application, the “fluid” is a continuous aqueous phase (a) and the “particles” may be any solid phase substance (b) that is capable of transport through the continuous aqueous phase (a) thereby resulting in Ostwald ripening of the substance (b) in the suspension composition. The continuous aqueous phase (a) comprises water. While it is to be appreciated that the suspension composition can comprise various components, the “continuous aqueous phase” generally refers to water alone. More specifically, the substance (b), when suspended in the continuous aqueous phase, exhibits the phenomenon referred to as “Ostwald ripening”. Ostwald ripening is a thermodynamically-driven spontaneous process wherein particles dispersed in a fluid change in size over time. Specifically, larger particles are more energetically favored than smaller particles. As a result, surface molecules detach from the smaller particles, are generally transported through the fluid by diffusion, and are incorporated into the larger particles. As the larger particles further increase in size over time, the incidence of the particles settling out of the fluid increases. Ostwald ripening can be readily observed by measuring differences in particle size over time for a given suspension composition (as described in further detail below). For purposes of the instant application, a substance (b) that is capable of transport through the continuous aqueous phase (a) to thereby result in Ostwald ripening exhibits an increase in mean particle size of the substance of at least 0.1 micrometers after storage of a suspension composition at a temperature of 40° Celsius for a period of 28 days or after freeze-thaw cycling of the suspension composition for 7 days at temperatures ranging from −15° Celsius to +5° Celsius. It is to be appreciated that increased temperatures can increase the occurrence of Ostwald ripening.

To facilitate transport through the continuous aqueous phase (a), the substance (b) has a degree of water solubility. However, the substance (b) typically has low solubility in the continuous aqueous phase (a). If the solubility of the substance (b) in the continuous aqueous phase (a) is too high molecules of the substance (b) will travel through the continuous aqueous phase (a) too rapidly. As a result, Ostwald ripening may be too high to control and the substance (b) may settle out of the continuous aqueous phase (a) even when a dispersing agent (c) (as described in further detail below) is included in the suspension composition. Thus, the substance (b) may have a water solubility of up to about 500 ppm, typically from about 10 to about 100 ppm at temperatures of from −15° Celsius to 54° Celsius. In some instances, the water solubility of the substance (b) can be from 100 ppm to 500 ppm at temperatures of from −15° Celsius to 54° Celsius. As described in further detail below, one particular advantage of the suspension compositions of the instant invention is the ability to use substances (b) that have water solubility in excess of 100 ppm, with limited Ostwald ripening experienced over time as compared to previously known suspension compositions.

The substance (b) is typically present in the suspension composition in the form of solid particles having a volume-weighted mean particle size of from about 1.5 to about 3.2 micrometers, alternatively from about 1.5 to about 2.8 micrometers. The substance (b) typically has the volume-weighted mean particle size within the aforementioned ranges even after freeze/thaw cycling and after storage under conditions of elevated temperature of about 54° C. for a period of about 28 days (as described in further detail below). However, the substance (b) is typically milled to an initial volume-weighted mean particle size of from about 1.5 to about 2.0 micrometers. Typically, the substance (b) has a volume-weighted mean particle size distribution that is mono-modal. The term “mono-modal” refers to a collection of particles which have a single, clearly discernable maxima on a particle size distribution curve (volume percent on the Y-axis, and particle size on the X-axis). For purposes of the suspension composition described herein, the “single clearly discernable maxima” is typically located on the particle size distribution curve from 1.5 to 3.2 micrometers. Additionally, about 90% of the particles of the substance (b) typically fall below a particle size of 3.8 micrometers. Further, the substance (b) is typically free of particles having a particle size greater than 10 micrometers. It is to be appreciated that, due to the fact that the substance (b) has a degree of solubility in the continuous aqueous phase (a), at least some of the O.R. substance may be dissolved within the suspension composition.

While the suspension composition of the instant invention is not limited to any particular type of substance, the substance is typically a pesticide component comprising a pesticide active ingredient. In this regard, the suspension composition may be a suspension concentrate that is used for water-based crop protection formulations. The pesticide component typically comprises only the pesticide active ingredient. However, it is to be appreciated that the pesticide component is not so limited and may comprise additional components that are known in the art. Additionally, it is to be appreciated that more than one pesticide active ingredient may be present in the substance (b). Examples of suitable pesticide active ingredients, for purposes of the instant invention, include but are not limited to atrazine, 3-(3,4-dichlorophenyl)-1,1-dimethylurea (commonly referred to by the tradename Diuron®), and carbaryl.

The substance (b) is typically present in the suspension composition in an amount of from about 20 to about 60 percent by weight, alternatively from about 30 to about 55 percent by weight, alternatively from about 40 to about 50 percent by weight, based on the total weight of said suspension composition. In this regard, the suspension composition typically includes relatively high amounts of the substance (b) as compared to formulations that are intended for end user use. For example, when the substance (b) is a pesticide component comprising a pesticide active ingredient, the suspension composition may be a suspension concentrate that is diluted with additional water to form water-based crop protection formulations that are then applied by end users to the crops.

As alluded to above, the suspension composition further comprises the dispersing agent (c). Due to the high amounts of substance (b) that are typically included in the suspension composition, and due to the relatively water-insoluble nature of the substance (b), the dispersing agent (c) is included in the suspension composition for purposes of stabilizing the substance (b) within the continuous aqueous phase (a) of the suspension composition, and the dispersing agent (c) performs equally as well as industry benchmark dispersing agents as determined through suspensibility tests that are described in detail below. The dispersing agent (c) that is included in the suspension compositions of the instant invention also inhibits or limits Ostwald ripening of the substance (b) within the suspension composition as described in further detail below, and such inhibition of Ostwald ripening has even been proven to be more effective than performance of industry benchmark dispersing agents in some circumstances.

The dispersing agent (c) comprises the reaction product of:
(i) at least one monomer represented by the general formula (I):

R₂C═CR—O—R¹ (OCₖH₂ₖ)ₙ—OH (I)
wherein R is hydrogen, an alkyl group or an aryl group; R¹ is an alkyl group having at least 2 carbon atoms; k is 2 to 4; and n is at least about 10, and
(ii) at least one additional monomer having unsaturated functionality and containing at least one carbonyl group. The reaction product of (i) and (ii) is a copolymer that is produced as a result of free radical polymerization between the at least one monomer (i) and the at least one additional monomer (ii). Such copolymers are commonly referred to as “comb” polymers due to the structure thereof comprising a backbone resulting from the free radical polymerization of the vinyl groups of the at least one monomer (i) and the at least one additional monomer (ii), and further comprising pendant groups extending from the backbone such as an alkylene oxide chain or similar structure from the at least one monomer (i) and the carbonyl group(s) from the at least one additional monomer (ii).

The at least one monomer (i) is generally referred to as an alkoxylated vinyl ether and can be prepared through methods known in the art such as, but not limited to, alkoxylating an alkoxy vinyl ether with an alkylene oxide having the formula OCₖH₂ₖ where k is the same as defined above. The at least one monomer (i) is used to incorporate the alkylene oxide chain or similar structure into the reaction product.

In formula (I) for the at least one monomer (i), the value of n determines the length of the alkylene oxide chain and substantially controls a number average molecular weight of the at least one monomer (i). Without being bound to any particular, theory, it is believed that the alkylene oxide chain enables the resulting comb polymers formed therefrom to wrap around molecules and/or small particles of substance (b) that are dissolved in the continuous aqueous phase and that would otherwise be prone to Ostwald ripening, with the resulting comb polymer thereby inhibiting the Ostwald ripening. For purposes of the instant application, the value of n is at least 10 as set forth above. Alternatively, n is from about 20 to about 150, alternatively from about 60 to about 130. It is to be appreciated that under some circumstances, the dispersing agent (c) can comprise the reaction product of more than one monomer (i) represented by the general formula (I). In one embodiment, the at least one monomer (i) is further defined as at least two different monomers each represented by the formula (I) wherein n is from about 20 to about 80 in at least one of the monomers represented by formula (I) and wherein n is greater than 80 in at least one of the other monomers represented by formula (I).

As set forth above, R¹ in formula (I) is an alkyl group having at least 2 carbon atoms, and typically has from 2 to 10 carbon atoms. Examples of monomers (i) represented by the formula (I) that are suitable for purposes of the instant invention include polyethylene glycol monovinyl ethers having a molecular weight of from about 1000 to 10,000 g/mol, alternatively from about 1000 to about 6000 g/mol.

The at least one additional monomer (ii) may comprise one or more unsaturated monocarboxylic acid derivatives such as any of those recited in U.S. Pat. No. 7,482,405, the portion of which recites unsaturated monocarboxylic acid derivatives is hereby incorporated by reference. Additionally, the at least one additional monomer (ii) may comprise one or more diesters of unsaturated dicarboxylic acids such as any of those recited in U.S. Pat. No. 7,482,405, the portion of which recites diesters of unsaturated dicarboxylic acids is hereby incorporated by reference. Typically, the at least one additional monomer (ii) has a structure represented by formula (II), or an anhydride thereof:

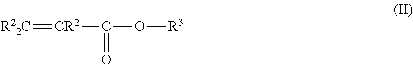

wherein R² is selected from the group of a hydrogen atom, an alkyl group, an aryl group,

and a carbonyl group, and

R³ is selected from the group of a hydrogen atom and a hydroxyalkyl group. For example, in one embodiment, R³ is a hydrogen atom and the at least one additional monomer can be acrylic acid. Alternatively, R³ is a hydroxyalkyl group and the at least one monomer can be a hydroxyalkyl acrylate or methacrylate. In one embodiment, the at least one additional monomer (ii) is further defined as at least two different additional monomers (ii) each represented by the formula (II), and the at least two different additional monomers (ii) can be selected from any of the aforementioned compounds set forth herein as suitable for the at least one additional monomer (ii). Without being bound to any particular theory, it is believed that under some circumstances dispersing agents (c) that comprise the reaction product of at least two different additional monomers (ii) provide the suspension composition with enhanced suspensibility, especially when the suspension composition is subject to freeze/thaw cycling and/or storage under conditions of elevated temperatures.

For the comb polymers comprising the reaction product of the at least one monomer (i) and the at least one additional monomer (ii), the first monomer (i) is typically reacted in a molar percent of from about 15 to about 50, more typically from about 25 to about 40 mole percent, based upon the total amount of all monomers reacted to form the dispersing agent.

Typically, the dispersing agent only comprises the reaction product of the at least one monomer (i) and the at least one additional monomer (ii) as described above. However, it is to be appreciated that the dispersing agent is not so limited and, under certain circumstances, the dispersing agent can comprise addition components.

The dispersing agent is present in the suspension composition in an amount sufficient to limit Ostwald ripening of the substance (b) in said suspension composition. Typically, the dispersing agent is present in an amount of from about 1 to about 5 percent by weight based on the total weight of all components present in the suspension composition, which is an amount sufficient to limit Ostwald ripening of the substance (b) in said suspension composition. Alternatively, the dispersing agent is present in the suspension composition in an amount of from about 1.5 to about 3 percent by weight, based on the total weight of all components present in the suspension composition.

The suspension composition can comprise further components other than the continuous aqueous phase (a), the substance (b), and the dispersing agent (c). For example, the suspension composition typically further comprises a wetting agent (f). Wetting agents are known in the art. Further additional components that may be included in the suspension composition include an antifreeze for purposes of improving freeze/thaw stability of the suspension composition, antifoams, and anti-settling agents such as xanthan gum. However, it is to be appreciated that the dispersing agent (c) described herein provides sufficiently acceptable suspensibility properties to the suspension composition, and sufficiently prevents Ostwald ripening, such that additional anti-settling agents are not required in many circumstances. However, depending upon the particular substance (b) that is included in the suspension composition, the anti-settling agent may be included in the suspension compositions to further stabilize the suspension compositions.

As alluded to above, by including the specific dispersing agents (c) in the suspension composition of the instant invention, diminished Ostwald ripening over time is experienced with the substance (b) in the suspension composition as compared to when other dispersing agents are used, and such performance with regard to inhibiting Ostwald ripening enables substances (b) that have higher water solubility than is currently acceptable to be used. In particular, a change in mean particle size of the substance (b) is typically less than about 0.8 micrometers after storage of the suspension composition at a temperature of about 54° C. for a period of about 28 days. However, it is to be appreciated that the instant invention is not limited to a particular change in mean particle size due to the fact that such values vary greatly based upon the particular substance (b) that is included in the suspension composition.

One method of preparing a suspension composition in accordance with the instant invention comprises the steps of combining the continuous aqueous phase (a), the substance (b), and the dispersing agent (c) to form a mixture in a vessel along with (d) grinding media. Grinding media are known in the art. The wetting agent (f) is also typically included in the vessel to form the mixture. The vessel is typically a bead chamber of an Eiger mill; however, the vessel may alternatively be a mixing vessel of an attritor such as a Union Process Attritor system. The method further comprises the step of decreasing a size of the substance (b) in the mixture to a volume-weighted average particle size of from about 1.5 to about 2.0 micrometers to form the suspension composition. The step of decreasing the size of the substance (b) typically occurs while chilling the mixture to prevent the substance (b) from decomposing or melting during milling.

The suspension composition may be stored at a temperature of about 54° C. for a period of about 28 days, under which conditions a change in mean particle size of the substance (b) may be less than about 0.8 micrometers after storage of the suspension composition under certain circumstances, which represents superior performance relative to Ostwald ripening of the substance (b) present in the suspension composition as compared to performance of benchmark dispersing agents.

The following examples are meant to illustrate the invention and are not to be viewed in any way as limiting to the scope of the invention.

### EXAMPLES

### Preparation of Suspension Compositions

Suspension concentrates are prepared including the components set forth in Table 1 below, with all amounts listed as percent by weight based on the total weight of the respective suspension composition.

TABLE 1

| Component | Ex. 1 | Ex. 2 | Ex. 3 | Ex. 4 | Ex. 5 | Ex. 6 |
|---|---|---|---|---|---|---|
| Water | 34.50 | 34.50 | 34.50 | 34.50 | 34.50 | 34.50 |
| Wetting | 3.50 | 3.50 | 3.50 | 3.50 | 3.50 | 3.50 |
| Agent A | | | | | | |
| Wetting | 0.00 | 0.00 | 0.00 | 0.00 | 0.00 | 0.00 |
| Agent B | | | | | | |
| Dispersing | 1.50 | 0.00 | 0.00 | 0.00 | 0.00 | 0.00 |
| Agent A | | | | | | |
| Dispersing | 0.00 | 1.50 | 0.00 | 0.00 | 0.00 | 0.00 |
| Agent B | | | | | | |
| Dispersing | 0.00 | 0.00 | 1.50 | 0.00 | 0.00 | 0.00 |
| Agent C | | | | | | |
| Dispersing | 0.00 | 0.00 | 0.00 | 1.50 | 0.00 | 0.00 |
| Agent D | | | | | | |
| Dispersing | 0.00 | 0.00 | 0.00 | 0.00 | 1.50 | 0.00 |
| Agent E | | | | | | |
| Dispersing | 0.00 | 0.00 | 0.00 | 0.00 | 0.00 | 1.50 |
| Agent F | | | | | | |
| Dispersing | 0.00 | 0.00 | 0.00 | 0.00 | 0.00 | 0.00 |
| Agent G | | | | | | |
| Dispersing | 0.00 | 0.00 | 0.00 | 0.00 | 0.00 | 0.00 |
| Agent H | | | | | | |
| Dispersing | 0.00 | 0.00 | 0.00 | 0.00 | 0.00 | 0.00 |
| Agent J | | | | | | |
| Substance 1 | 50.00 | 50.00 | 50.00 | 50.00 | 50.00 | 50.00 |
| Substance 2 | 0.00 | 0.00 | 0.00 | 0.00 | 0.00 | 0.00 |
| Additional | 10.00 | 10.00 | 10.00 | 10.00 | 10.00 | 10.00 |
| Component A | | | | | | |
| Additional | 0.50 | 0.50 | 0.50 | 0.50 | 0.50 | 0.50 |
| Component B | | | | | | |
| Additional | 0.00 | 0.00 | 0.00 | 0.00 | 0.00 | 0.00 |
| Component C | | | | | | |
| Total | 100.00 | 100.00 | 100.00 | 100.00 | 100.00 | 100.00 |
| Component | Ex. 7 | Ex. 8 | Ex. 9 | Ex. 10 | Ex. 11 | Ex. 12 |
| Water | 34.50 | 34.50 | 34.50 | 34.50 | 34.30 | 34.30 |
| Wetting | 3.50 | 3.50 | 3.50 | 3.50 | 3.50 | 3.50 |
| Agent A | | | | | | |
| Wetting | 0.00 | 0.00 | 0.00 | 0.00 | 0.00 | 0.00 |
| Agent B | | | | | | |
| Dispersing | 0.00 | 0.00 | 0.00 | 0.00 | 0.00 | 0.00 |
| Agent A | | | | | | |
| Dispersing | 0.00 | 1.50 | 0.00 | 0.00 | 1.50 | 0.00 |
| Agent B | | | | | | |
| Dispersing | 0.00 | 0.00 | 1.50 | 0.00 | 0.00 | 0.00 |
| Agent C | | | | | | |
| Dispersing | 0.00 | 0.00 | 0.00 | 0.00 | 0.00 | 0.00 |
| Agent D | | | | | | |
| Dispersing | 0.00 | 0.00 | 0.00 | 0.00 | 0.00 | 0.00 |
| Agent E | | | | | | |
| Dispersing | 1.50 | 0.00 | 0.00 | 0.00 | 0.00 | 1.50 |
| Agent F | | | | | | |
| Dispersing | 0.00 | 0.00 | 0.00 | 1.50 | 0.00 | 0.00 |
| Agent G | | | | | | |
| Dispersing | 0.00 | 0.00 | 0.00 | 0.00 | 0.00 | 0.00 |
| Agent H | | | | | | |
| Dispersing | 0.00 | 0.00 | 0.00 | 0.00 | 0.00 | 0.00 |
| Agent J | | | | | | |
| Substance 1 | 50.00 | 50.00 | 50.00 | 50.00 | 0.00 | 0.00 |
| Substance 2 | 0.00 | 0.00 | 0.00 | 0.00 | 50.00 | 50.00 |
| Additional | 10.00 | 10.00 | 10.00 | 10.00 | 10.00 | 10.00 |
| Component A | | | | | | |
| Additional | 0.50 | 0.50 | 0.50 | 0.50 | 0.50 | 0.50 |
| Component B | | | | | | |
| Additional | 0.00 | 0.00 | 0.00 | 0.00 | 0.20 | 0.20 |
| Component C | | | | | | |
| Total | 100.00 | 100.00 | 100.00 | 100.00 | 100.00 | 100.00 |
| | Comp | Comp. | Comp. | Comp | Comp | Comp. |
| Component | Ex. 1 | Ex. 2 | Ex. 3 | Ex. 4 | Ex. 5 | Ex. 6 |
| Water | 34.50 | 34.50 | 34.50 | 34.50 | 34.50 | 34.30 |
| Wetting | 3.50 | 0.00 | 3.50 | 3.50 | 0.00 | 3.50 |
| Agent A | | | | | | |
| Wetting | 0.00 | 3.50 | 0.00 | 0.00 | 3.50 | 0.00 |
| Agent B | | | | | | |
| Dispersing | 0.00 | 0.00 | 0.00 | 0.00 | 0.00 | 0.00 |
| Agent A | | | | | | |
| Dispersing | 0.00 | 0.00 | 0.00 | 0.00 | 0.00 | 0.00 |
| Agent B | | | | | | |
| Dispersing | 0.00 | 0.00 | 0.00 | 0.00 | 0.00 | 0.00 |
| Agent C | | | | | | |
| Dispersing | 0.00 | 0.00 | 0.00 | 0.00 | 0.00 | 0.00 |
| Agent D | | | | | | |
| Dispersing | 0.00 | 0.00 | 0.00 | 0.00 | 0.00 | 0.00 |
| Agent E | | | | | | |
| Dispersing | 0.00 | 0.00 | 0.00 | 0.00 | 0.00 | 0.00 |
| Agent F | | | | | | |
| Dispersing | 0.00 | 0.00 | 0.00 | 0.00 | 0.00 | 0.00 |
| Agent G | | | | | | |
| Dispersing | 1.50 | 0.00 | 1.50 | 1.50 | 0.00 | 1.50 |
| Agent H | | | | | | |
| Dispersing | 0.00 | 1.50 | 0.00 | 0.00 | 1.50 | 0.00 |
| Agent J | | | | | | |
| Substance 1 | 50.00 | 50.00 | 50.00 | 50.00 | 50.00 | 0.00 |
| Substance 2 | 0.00 | 0.00 | 0.00 | 0.00 | 0.00 | 50.00 |
| Additional | 10.00 | 10.00 | 10.00 | 10.00 | 10.00 | 10.00 |
| Component A | | | | | | |
| Additional | 0.50 | 0.50 | 0.50 | 0.50 | 0.50 | 0.50 |
| Component B | | | | | | |
| Additional | 0.00 | 0.00 | 0.00 | 0.00 | 0.00 | 0.20 |
| Component C | | | | | | |
| Total | 100.00 | 100.00 | 100.00 | 100.00 | 100.00 | 100.00 |

Wetting Agent A is Pluriol® WSB 125.

Wetting Agent B is Morwet® D425.

Dispersing Agent A is the reaction product of maleic anhydride and an alkoxylated vinyl ether having a number average molecular weight of about 1100 g/mol, commercially available from BASF Corporation.

Dispersing Agent B is the reaction product of acrylic acid, an unsaturated hydroxyalkyl ester, and two different alkoxylated vinyl ethers having a number average molecular weight of about 1100 and 5800 g/mol, respectively, the two different vinyl ethers reacted in a molar ratio of about 9:1, respectively, commercially available from BASF Corporation.

Dispersing Agent C is the reaction product of acrylic acid, maleic anhydride, and an alkoxylated vinyl ether having a number average molecular weight of about 1100 g/mol, commercially available from BASF Corporation.

Dispersing Agent D is the reaction product of maleic anhydride, an unsaturated hydroxyalkyl ester, and two different alkoxylated vinyl ethers having a number average molecular weight of about 1100 and 5800 g/mol, respectively, commercially available from BASF Corporation.

Dispersing Agent E is the reaction product of acrylic acid and an alkoxylated vinyl ether having a number average molecular weight of about 3000 g/mol, commercially available from BASF Corporation.

Dispersing Agent F is the reaction product of acrylic acid, an unsaturated hydroxyalkyl ester, and two different alkoxylated vinyl ethers having a number average molecular weight of about 1100 and 5800 g/mol, respectively, the two different vinyl ethers reacted in a molar ratio of about 1:4, respectively, commercially available from BASF Corporation.

Dispersing Agent G is the reaction product of acrylic acid, maleic anhydride, and an alkoxylated vinyl ether having a number average molecular weight of about 5800 g/mol, commercially available from BASF Corporation.

Dispersing Agent H is Atlox® 4913.

Dispersing Agent J is a difunctional block copolymer surfactant terminating in primary hydroxyl groups, commercially available from BASF Corporation.

Substance 1 is atrazine.

Substance 2 is 3-(3,4-dichlorophenyl)-1,1-dimethylurea.

Additional Component A is propylene glycol.

Additional Component B is an antifoaming agent.

Additional Component C is xanthan gum.

The suspension compositions are prepared by first weighing the appropriate amount of water to be used for purposes of preparing the suspension compositions and adding the water to a vessel. The appropriate amounts of the Dispersing Agent and Wetting Agent are then determined according to the values set forth in Table 1 and are added to the vessel. The contents of the vessel are then mixed until the Dispersing Agent and Wetting Agent are dispersed in the water.

The Substance is then added to the vessel followed by mixing until the contents of the vessel appear uniform. The Additional Components are then added to the vessel, the vessel is covered, and the contents of the vessel are mixed for about 1 hour.

An Eiger Mini 50 Bead Mill comprising a bead chamber is then used to mill the contents of the vessel to form the suspension composition. The bead chamber is chilled using a chiller system with a coolant comprising a 50/50 parts by volume water/propylene glycol mixture. To mill the contents of the vessel, zirconium grinding media having an average diameter of from about 0.8 to about 1.0 mm is included in the bead chamber in an amount of about 80 mL. The chiller system is then used to chill the bead chamber to a temperature of from about 5-10° C. A diverter valve of the bead mill is then set to recirculate. The contents of the vessel are then added to the bead chamber and milling is commenced with the bead mill in recirculation mode, with care taken to ensure that a temperature of the contents of the bead chamber does not exceed 40° C. Samples are periodically taken from the bead mill to measure particle size, until a volume weighted particle size of the samples is measured to be from about 1.7 to about 2.0 micrometers, with no particles larger than 10 micrometers. Achievement of the desired particle size indicates achievement of the suspension composition, and the contents of the bead chamber (excluding the beads) are collected for testing.

For testing purposes, the suspension compositions of the instant invention are subjected to freeze/thaw cycling and storage under conditions of elevated temperatures as follows:

### Freeze/Thaw Cycling

Freeze-thaw cycling of the suspension composition is performed by repeated temperature cycling of a test sample of the suspension composition from −15° C. to +5° C. Each freeze-thaw cycle is 1 week in duration and includes 3.5 days of storage at −15° C., followed by 3.5 days storage at +5° C. After completing a minimum of 6 freeze/thaw cycles, the physical properties of the sample are evaluated and compared to initial measurements to determine effects that may adversely alter the useful handling and end use properties of the suspension composition.

### Storage Under Conditions of Elevated Temperatures

Storage under conditions of elevated temperatures is performed by placing a sample of the suspension composition in an oven held at a temperature of the surrounding air of 54° C. for a period of about 28 days, after which time physical properties of the sample are evaluated and compared to initial measurements to determine effects that may adversely alter the useful handling and end use properties of the suspension composition.

Physical properties of the suspension compositions are measured in accordance with the following procedures, with the physical properties measured initially after preparation of the suspension compositions, after freeze/thaw cycling, and after storage under conditions of elevated temperatures as described above.

### Measurement of Particle Size in the Suspension Compositions

Samples of the suspension composition are dispersed in deionized water and analyzed for particle size using a Malvern Mastersizer 2000 Particle Size Analyzer commercially available from Malvern Instruments, Southborough, Mass. The sample is dispersed using a small volume recirculator and operations are performed using a standard operating procedure (SOP) created specifically to include such sample parameters as refractive index, mixing speed, analysis time, and number of measurements. Analysis is based on spherical assumptions and results are reported in terms of a volume-weighted mean diameter (i.e., volume-weighted mean particle size). Results are based on an acquisition range of 0.02-2000 μm and on the average of two runs.

Initial particle sizes for each of the Examples and Comparative Examples as described above are set forth in Table 2 below.

TABLE 2

| | Volume-Weighted Mean |
|---|---|
| Component | Particle Size, micrometers |
| Example 1 | 1.707 |
| Example 2 | 1.866 |
| Example 3 | 1.883 |
| Example 4 | 1.660 |
| Example 5 | 1.719 |
| Example 6 | 1.752 |
| Example 7 | 1.731 |
| Example 8 | 1.713 |
| Example 9 | 1.698 |
| Example 10 | 1.780 |
| Example 11 | 1.914 |
| Example 12 | 1.968 |
| Comparative Example 1 | 1.598 |
| Comparative Example 2 | 1.450 |
| Comparative Example 3 | 1.640 |
| Comparative Example 4 | 1.700 |
| Comparative Example 5 | 1.483 |
| Comparative Example 6 | 1.570 |

Particle sizes for each of the Examples and Comparative Examples as described above are set forth in Table 3 below after subjecting the Examples and Comparative Examples to freeze/thaw cycling as described above. The change in particle size after freeze/thaw cycling is indicative of Ostwald ripening occurring within the respective suspension compositions.

TABLE 3

| | Volume-Weighted | Change in | Change in |
|---|---|---|---|
| | Mean Particle Size, | particle size, | particle size, |
| Component | micrometers | micrometers | % |
| Example 1 | 2.102 | 0.395 | 23.14 |
| Example 2 | 2.309 | 0.443 | 23.74 |
| Example 3 | 2.042 | 0.159 | 8.44 |
| Example 4 | 1.730 | 0.070 | 4.22 |
| Example 5 | 1.785 | 0.066 | 3.84 |
| Example 6 | 1.801 | 0.049 | 2.80 |
| Example 7 | 1.707 | −0.024 | −1.39 |
| Example 8 | 1.686 | −0.027 | −1.58 |
| Example 9 | 1.661 | −0.307 | −18.08 |
| Example 10 | 1.787 | 0.007 | 0.39 |
| Example 11 | — | — | — |
| Example 12 | — | — | — |
| Comparative | 1.619 | 0.021 | 1.31 |
| Example 1 | | | |
| Comparative | 1.415 | −0.035 | −2.41 |
| Example 2 | | | |
| Comparative | 1.626 | −0.014 | −0.85 |
| Example 3 | | | |
| Comparative | 1.676 | −0.024 | −1.41 |
| Example 4 | | | |
| Comparative | 1.458 | −0.025 | −1.69 |
| Example 5 | | | |
| Comparative | — | — | — |
| Example 6 | | | |

Statistical analysis for the increases in particle size after freeze/thaw cycling is performed using JMP 8 software. The results in the statistical analysis indicate that the differences in the volume-weighted mean particle sizes between the Examples and Comparative Examples are not statistically significant, thereby indicating that the dispersing agents used in the Examples are as effective as the dispersing agents used in the Comparative Examples.

Particle sizes for each of the Examples and Comparative Examples as described above are set forth in Table 4 below after subjecting the Examples and Comparative Examples to storage under conditions of elevated temperature as described above. The change in particle size after storage under conditions of elevated temperature is also indicative of Ostwald ripening occurring within the respective suspension compositions.

### TABLE 4

TABLE 4

| | Volume -Weighted | Change in | Change in |
|---|---|---|---|
| | Mean Particle Size, | particle size, | particle size, |
| Component | micrometers | micrometers | % |
| Example 1 | 1.979 | 0.272 | 15.9 |
| Example 2 | 2.122 | 0.256 | 13.7 |
| Example 3 | 1.901 | 0.018 | 1.0 |
| Example 4 | 1.981 | 0.321 | 19.3 |
| Example 5 | 1.973 | 0.254 | 14.8 |
| Example 6 | 1.952 | 0.200 | 11.4 |
| Example 7 | 2.022 | 0.291 | 16.8 |
| Example 8 | 2.021 | 0.308 | 18.0 |
| Example 9 | 2.035 | 0.337 | 19.8 |
| Example 10 | 2.117 | 0.337 | 18.9 |
| Example 11 | 2.696 | 0.782 | 40.9 |
| Example 12 | 2.661 | 0.693 | 35.2 |
| Comparative | 1.741 | 0.143 | 8.9 |
| Example 1 | | | |
| Comparative | 1.757 | 0.307 | 21.2 |
| Example 2 | | | |
| Comparative | 1.798 | 0.158 | 9.6 |
| Example 3 | | | |
| Comparative | 1.873 | 0.173 | 10.2 |
| Example 4 | | | |
| Comparative | 1.788 | 0.305 | 20.6 |
| Example 5 | | | |
| Comparative | 3.081 | 1.511 | 96.2 |
| Example 6 | | | |

Statistical analysis for the increase in particle size after storage under conditions of elevated temperature is also performed using JMP 8 software. The results in the statistical analysis indicate that the differences in the volume-weighted mean particle sizes between Examples 1-10 and Comparative Examples 1-5 are not statistically significant, thereby indicating that the dispersing agents used in these Examples are as effective as the dispersing agents used in the respective Comparative Examples. However, differences in the volume-weighted mean particle sizes between Examples 12 and 12 and Comparative Example 6 (where the Substance used is 3-(3,4-dichlorophenyl)-1,1-dimethylurea, which is more water soluble than atrazine) indicate that statistically significant minimization of Ostwald ripening is achieved when the dispersing agents of the Examples are used instead of the dispersing agents in the Comparative Example.

### Suspensibility Test

To test for suspensibility of the suspension compositions, 150 ml of standard hard water (containing hard water ions such as magnesium and calcium in an amount of about 342 ppm with a molar ratio of calcium ions to magnesium ions of about 2:1) is measured in a 250 ml beaker. A magnetic stirrer is placed in the beaker and the beaker is placed on a stir plate. Speed for the stir plate is set such that a vortex does not reach the stir bar.

5.00±0.10 grams of the suspension composition is then weighed in a weight-boat and placed into the beaker. A timer is started immediately and set for 2 minutes, with stirrer speed adjusted after adding the sample of the suspension composition to the beaker to ensure good mixing.

After 2 minutes of mixing, the beaker is removed from the stir plate. The magnetic stirrer is removed and rinsed using a wash bottle filled with standard hard water. The contents of the beaker are then poured into a 250 ml graduated cylinder and the beaker is rinsed with the rinsate added to the 250 ml graduated cylinder. The volume in the cylinder is brought up to 250 ml using standard hard water. The steps of emptying and rinsing the beaker are performed within 1 minute.

The 250 ml graduated cylinder is then sealed and inverted for 15 cycles at 2-3 seconds per cycle and is then allowed to stand undisturbed at ambient temperature for 30 minutes.

225 ml of the suspension is then withdrawn from the 250 ml graduated cylinder within 10-25 seconds using a pipette, always keeping the pipette tip only a few mm below the surface of the liquid in the 250 ml graduated cylinder, with care taken to minimize disturbance of the entire cylinder. The liquid withdrawn using the pipette is discarded.

A dry evaporating dish is weighed to the nearest 0.05 grams. The remaining 25 ml in the 250 ml graduated cylinder is swirled to suspend particles present therein, and the contents of the 250 ml graduated cylinder are poured into the evaporating dish. The 250 ml graduated cylinder is rinsed, with the rinsate added to the evaporating dish.

The evaporating dish is then placed in a drying oven and allowed to dry overnight. When the contents of the evaporating dish are dry, the evaporating dish is removed from the oven and allowed to sit at room temperature of about 21° C. for 5 minutes. The evaporating dish is then weighed.

Suspensibility is then determined by subtracting the weight of the residue in the evaporating dish from the mass of solids in the initial sample of the suspension composition, and then dividing the result by the weight of the residue in the evaporating dish (and multiplying by 100 to obtain a percentage). Suspensibility is determined both initially, after storage at 54° C. for 28 days, and after freeze/thaw cycling, and the results are shown in Table 5 below.

TABLE 5

| | | Final | |
|---|---|---|---|
| | Initial | Suspensibility After | Final Suspensibility |
| | Suspensibility, | Storage at 54° C. | After Freeze/Thaw |
| Component | % | for 28 Days, % | Cycling, % |
| Example 1 | 93.4 | 89.68 | 90.43 |
| Example 2 | 94.5 | 87.83 | 76.42 |
| Example 3 | 89.7 | 91.35 | 92.66 |
| Example 4 | 90.9 | 91.06 | 91.57 |
| Example 5 | 90.8 | 90.66 | 67.03 |
| Example 6 | 93.0 | 87.11 | 91.54 |
| Example 7 | 91.73 | NA | 90.50 |
| Example 8 | 90.46 | 83.84 | 93.01 |
| Example 9 | 91.65 | 87.48 | 92.28 |
| Example 10 | 91.16 | 88.22 | 91.90 |
| Example 11 | 90.90 | 87.83 | 88.62 |
| Example 12 | 88.63 | 87.25 | 90.06 |
| Comparative | 91.5 | 88.05 | 91.57 |
| Example 1 | | | |
| Comparative | 91.73 | 90.83 | 91.73 |
| Example 2 | | | |
| Comparative | 90.86 | NA | 89.36 |
| Example 3 | | | |
| Comparative | 89.44 | 86.67 | 93.73 |
| Example 4 | | | |
| Comparative | 90.06 | 88.96 | 88.71 |
| Example 5 | | | |
| Comparative | 91.91 | 89.37 | 92.64 |
| Example 6 | | | |

The results of the suspensibility tests for each of the Examples and Comparative Examples as described above, both after freeze/thaw cycling and after storage under conditions of elevated temperature, indicate that the differences in the volume-weighted mean particle sizes between Examples 1-4 and 6-10 and Comparative Examples 1-5 are not statistically significant. However, with regard to Example 5, results of the suspensibility tests, while not statistically significant both after storage under conditions of elevated temperature, were statistically lower than suspensibility of the rest of the Examples and Comparative Examples after freeze/thaw cycling.

### Wet Screen Analysis

Wet Screen Analysis is performed according to a procedure described in the CIPAC handbook under Wet Sieving MT 59.3. Initial testing is done as soon as possible after preparing the suspension compositions in the Eiger Mini 50 mill. If the initial testing is satisfactory, a sample is tested that has undergone 6 weeks of freeze/thaw cycling.

To perform the Wet Screen Analysis, 3 inch sieves of 50, 100 and 325 mesh are used and are dried in an oven at 50° C. overnight in preparation for the testing. The sieves are weighed individually.

25 gm of the suspension composition is added to a 600 mL beaker, and the beaker is filled to the 400 mL mark with tap water. The contents of the 600 mL beaker are then stirred with a magnetic stirrer for 5 minutes with a minimal vortex.

The stacked sieves are wetted with tap water and the suspension composition is then poured through the sieves. While stacked, the sieves are rinsed with tap water to ensure that all of the suspension composition that can pass through the sieves does so. The sieves are then dried in a 50° C. oven overnight, and the sieves are reweighed.

A percent of the suspension composition retained on each sieve is calculated as follows:

Wt. of the Sieve Plus Residue−Wt. of the Sieve=Wt. of the Residue % Residue=Wt. of Residue/25*100

The percent of the suspension composition retained on each sieve is set forth below in Table 6 (for initial results), Table 7 (for results after storage under conditions of elevated temperature of 54° C. for a period of 28 days), and Table 8 (for results after freeze/thaw cycling).

TABLE 6

| | Retention on | Retention on | Retention on |
|---|---|---|---|
| | 50 mesh Wet | 100 mesh Wet | 300 mesh Wet |
| Component | Screen (%) | Screen (%) | Screen (%) |
| Example 1 | 0.03 | 0.03 | 0.03 |
| Example 2 | 0.08 | 0.04 | 0.00 |
| Example 3 | 0.00 | 0.08 | 0.08 |
| Example 4 | 0.00 | 0.04 | 0.00 |
| Example 5 | 0.36 | 0.48 | 0.16 |
| Example 6 | 0.00 | 0.04 | 0.31 |
| Example 7 | 0.00 | 0.00 | 0.00 |
| Example 8 | 0.04 | 0.04 | 0.16 |
| Example 9 | 0.08 | 0.08 | 0.08 |
| Example 10 | 0.00 | 0.00 | 0.00 |
| Example 11 | — | — | — |
| Example 12 | — | — | — |
| Comparative | 0.04 | 0.04 | 0.08 |
| Example 1 | | | |
| Comparative | 0.04 | 0.04 | 0.00 |
| Example 2 | | | |
| Comparative | 0.00 | 0.00 | 0.00 |
| Example 3 | | | |
| Comparative | 0.00 | 0.00 | 0.04 |
| Example 4 | | | |
| Comparative | 0.08 | 0.08 | 0.00 |
| Example 5 | | | |
| Comparative | — | — | — |
| Example 6 | | | |

TABLE 7

| | Retention on | Retention on | Retention on |
|---|---|---|---|
| | 50 mesh Wet | 100 mesh Wet | 300 mesh Wet |
| Component | Screen (%) | Screen (%) | Screen (%) |
| Example 1 | 0.04 | 0.04 | 0.04 |
| Example 2 | 0.04 | 0.00 | 0.00 |
| Example 3 | 0.08 | 0.00 | 0.04 |
| Example 4 | 0.00 | 0.04 | 0.00 |
| Example 5 | 0.36 | 0.48 | 0.16 |
| Example 6 | 0.00 | 0.07 | 0.07 |
| Example 7 | — | — | — |
| Example 8 | 0.08 | 0.04 | 0.04 |
| Example 9 | 0.04 | 0.08 | 0.08 |
| Example 10 | 0.00 | 0.05 | 0.00 |
| Example 11 | — | — | — |
| Example 12 | — | — | — |
| Comparative | 0.00 | 0.00 | 0.00 |
| Example 1 | | | |
| Comparative | 0.04 | 0.00 | 0.00 |
| Example 2 | | | |
| Comparative | — | — | — |
| Example 3 | | | |
| Comparative | 0.00 | 0.00 | 0.00 |
| Example 4 | | | |
| Comparative | 0.04 | 0.00 | 0.00 |
| Example 5 | | | |
| Comparative | — | — | — |
| Example 6 | | | |

TABLE 8

| | Retention on | Retention on | Retention on |
|---|---|---|---|
| | 50 mesh Wet | 100 mesh Wet | 300 mesh Wet |
| Component | Screen (%) | Screen (%) | Screen (%) |
| Example 1 | 0.16 | 0.20 | 0.12 |
| Example 2 | 6.20 | 3.20 | 0.56 |
| Example 3 | 0.08 | 0.04 | 0.04 |
| Example 4 | 0.08 | 0.08 | 0.08 |
| Example 5 | 0.15 | 0.12 | 0.08 |
| Example 6 | 0.00 | 0.04 | 0.00 |
| Example 7 | 0.04 | 0.08 | 0.08 |
| Example 8 | 0.08 | 0.04 | 0.04 |
| Example 9 | 0.00 | 0.04 | 0.00 |
| Example 10 | 0.16 | 0.16 | 0.20 |
| Example 11 | — | — | — |
| Example 12 | — | — | — |
| Comparative | 0.16 | 0.08 | 0.08 |
| Example 1 | | | |
| Comparative | 0.08 | 0.04 | 0.08 |
| Example 2 | | | |
| Comparative | 0.04 | 0.04 | 0.04 |
| Example 3 | | | |
| Comparative | 0.04 | 0.04 | 0.08 |
| Example 4 | | | |
| Comparative | 0.04 | 0.04 | 0.08 |
| Example 5 | | | |
| Comparative | — | — | — |
| Example 6 | | | |

In the majority of the wet screen tests, the suspension compositions of Examples performed as well as the suspension compositions of Comparative Examples 1-5, with only negligible amounts of the suspension composition retained.

A considerable amount of suspension composition was retained Example 2. However, this result was inconsistent with the Malvern particle size analysis in which no large particles were detected. When the suspension composition of Example 2 was prepared and tested a second time (represented by Example 8), no retain was observed in the wet screen test. Given the good performance of the suspension composition on repeat and the lack of large particles observed in Malvern particle size data, the poor wet sieve results for Example 2 are believed to be the result of either sample contamination or of evaporation of the aqueous phase as might happen if the sample bottle was left uncapped for an extended amount of time.

Obviously, many modifications and variations of the present invention are possible in light of the above teachings, and the invention may be practiced otherwise than as specifically described within the scope of the appended claims. It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

1. A suspension composition comprising:
a) a continuous aqueous phase;
b) a substance capable of transport through the aqueous phase thereby resulting in Ostwald ripening of said substance in said suspension composition; and
c) a dispersing agent comprising the reaction product of:
(i) at least one monomer represented by the general formula (I):
R₂C═CR—O—R¹—(OCₖH₂ₖ)ₙ—OH (I)
wherein R is hydrogen, an alkyl group or an aryl group; R¹ is an alkyl group having at least 2 carbon atoms; k is 2 to 4; and n is at least about 10,
(ii) at least one additional monomer having unsaturated functionality and containing at least one carbonyl group,
said dispersing agent present in an amount sufficient to limit Ostwald ripening of said substance (b) in said suspension composition.

2. A suspension composition as set forth in claim 1 wherein n is from about 20 to about 150.

3. A suspension composition as set forth in claim 1 wherein the at least one monomer (i) is further defined as at least two different monomers each represented by the formula (I) wherein n is from about 20 to about 80 in at least one of the monomers represented by formula (I) and wherein n is greater than 80 in at least one of the other monomers represented by formula (I).

4. A suspension composition as set forth in claim 1 wherein the at least one additional monomer (ii) has a structure represented by formula (II) or an anhydride thereof: 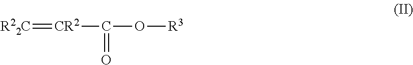
wherein R² is selected from the group of a hydrogen atom, an alkyl group, an aryl group,
and a carbonyl group, and
R³ is selected from the group of a hydrogen atom and a hydroxyalkyl group.

5. A suspension composition as set forth in claim 4 wherein R³ is a hydrogen atom.

6. A suspension composition as set forth in claim 4 wherein the at least one additional monomer (ii) is further defined as at least two different additional monomers each represented by the formula (II).

7. A suspension composition as set forth in claim 1 wherein the first monomer (i) is reacted in a molar percent of from about 15 to about 50 based upon the total amount of all monomers reacted to form the dispersing agent.

8. A suspension composition as set forth in claim 1 wherein solubility of said substance (b) in water is up to about 500 ppm at temperatures of from −15° Celsius to 54° Celsius.

9. A suspension composition as set forth in claim 1 wherein said substance is further defined as a pesticide component comprising a pesticide active ingredient.

10. A suspension composition as set forth in claim 9 wherein said pesticide active ingredient is further defined as atrazine.

11. A suspension composition as set forth in claim 9 wherein said pesticide active ingredient is further defined as 3-(3,4-dichlorophenyl)-1,1-dimethylurea.

12. A suspension composition as set forth in claim 1 wherein said substance (b) is present in an amount of from about 20 to about 60 percent by weight based on the total weight of said suspension composition.

13. A suspension composition as set forth in claim 1 wherein said substance (b) is present in the form of particles having a volume-weighted mean particle size of from 1.5 to 3.2 micrometers.

14. A suspension composition as set forth in claim 13 wherein a change in mean particle size of the substance (b) is less than about 0.8 micrometers after storage of the suspension composition at a temperature of about 54° C. for a period of about 28 days.

15. (canceled)

16. A method of preparing a suspension composition comprising the steps of:
(I) combining the following components to form a mixture in a vessel:
(a) a continuous aqueous phase;
(b) a substance capable of transport through the aqueous phase thereby resulting in Ostwald ripening of the substance in the aqueous phase;
(c) a dispersing agent comprising the reaction product of:
(i) a least one monomer represented by the general formula (I):
R₂C═CR—O—R¹—(OCₖH₂ₖ)ₙ—OH
wherein R is hydrogen, an alkyl group or an aryl group; R¹ is an alkyl group having at least 2 carbon atoms; k is 2 to 4; and n is at least about 10,
(ii) at least one additional monomer having unsaturated functionality and containing at least one functional group selected from the group of carboxylic acid groups, hydroxyalkyl groups, and combinations thereof, and
(d) grinding media;
(II) decreasing a size of the substance (b) in the mixture to a volume-weighted average particle size of from about 1.5 to about 2.0 micrometers to form the suspension composition.

17. (canceled)

18. A method as set forth in claim 16 wherein the at least one additional monomer (ii) has a structure represented by formula (II) or an anhydride thereof: 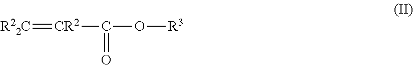
wherein R² is selected from the group of a hydrogen atom, an alkyl group, an aryl group,
and a carbonyl group, and
R³ is selected from the group of a hydrogen atom and a hydroxyalkyl group.

19. A method as set forth in claim 18 wherein the at least one additional monomer (ii) is further defined as at least two different additional monomers each represented by the formula (II).

20. A method as set forth in claim 16 wherein solubility of the substance (b) in water is up to about 500 ppm at temperatures of from −15° Celsius to 54° Celsius.

21. A method as set forth in claim 16 wherein the substance is further defined as a pesticide component comprising a pesticide active ingredient.

22. A method as set forth in claim 21 wherein the pesticide active ingredient is further defined as atrazine.

23. A method as set forth in claim 21 wherein the pesticide active ingredient is further defined as 3-(3,4-dichlorophenyl)-1,1-dimethylurea.

24. A method as set forth in claim 16 wherein the substance (b) is combined in an amount of from about 20 to about 60 percent by weight based on the total weight of all components combined in step (I).

25. A method as set forth in claim 16 further comprising the step of storing the suspension composition at a temperature of about 54° C. for a period of about 28 days.

26. A method as set forth in claim 25 wherein a change in mean particle size of the substance (b) is less than about 0.8 micrometers after storage of the suspension composition.
